(19) United States
(12) Patent Application Publication
(10) Pub. No.: US 2026/0080151 A1
(43) Pub. Date: Mar. 19, 2026

(54) SYSTEMS AND METHODS FOR ELECTRONICALLY SIGNING HTML FORMS

(71) Applicant: WELLS FARGO BANK, N.A., San Francisco, CA (US)

(72) Inventors: Mark A. Vos, Norwalk, IA (US); Ujwal Shrestha, San Antonio, TX (US); Mounir Laaraj, Frisco, TX (US)

(21) Appl. No.: 18/887,695

(22) Filed: Sep. 17, 2024

(51) Int. Cl. G06F 40/143; G06F 21/64; G06F 40/103; G06F 40/171

(52) U.S. Cl. CPC G06F 40/143; G06F 21/64; G06F 40/103; G06F 40/171

(57) ABSTRACT

Systems and methods for electronically signing HTML forms including retrieving a HTML-formatted document; assigning data capture and signing rules to the HTML-formatted document; converting the HTML-formatted document to a PDF-formatted document. transmitting a signature request to sign the HTML-formatted document; receiving a signature input on the HTML-formatted document; applying the signature input to the PDF-formatted document; and transmitting the PDF-formatted document.

### FIELD OF INVENTION

The present disclosure generally relates to electronic signature interface, and more specifically to systems and methods for electronically signing HTML-formatted documents which may then be converted PDF-formatted documents.

### BACKGROUND

Electronic signatures, or E-signatures, are an increasingly popular means of certifying documents. E-signatures are often more efficient for purposes of certifying documents compared to providing traditional signatures, as E-signatures may be communicated electronically allowing for much faster file transfer, review, signature, and archiving. Current E-signature interfaces lack the capability to receive signatures in a responsive fashion, (e.g., through mobile devices), as traditionally, E-Signatures are performed on PDF documents, which comprise rasterized images. Such rasterized images are not mobile friendly as they allow for pinch-zoom capabilities, but not for more mobile friendly and responsive means of navigating documents.

### SUMMARY

According to certain examples, an eSignature platform performs a method including retrieving a HTML-formatted document; assigning data capture and signing rules to the HTML-formatted document; converting the HTML-formatted document to a PDF-formatted document. transmitting a signature request to sign the HTML-formatted document; receiving a signature input on the HTML-formatted document; applying the signature input to the PDF-formatted document; and transmitting the PDF-formatted document.

Another example relates to a system including one or more processors. The one or more processors are configured to: retrieve a signing document comprising a HTML-formatted document; assign data capture and signing rules to the HTML-formatted document; convert the HTML-formatted document to a PDF-formatted document; transmit a signature request to a user to sign the HTML-formatted document; receive a signature input on the HTML-formatted document, apply the signature input to the PDF-formatted document; and transmit the PDF-formatted document.

A further example relates to a non-transitory computer readable medium comprising instructions that, when executed by one or more processors, cause the one or more processors to: retrieve a signing document comprising a HTML-formatted document; assign data capture and signing rules to the HTML-formatted document; convert the HTML-formatted document to a PDF-formatted document; transmit a signature request to a user to sign the HTML-formatted document; receive a signature input; apply the signature input to the PDF-formatted document; and transmit the PDF-formatted document.

These illustrative aspects and features are mentioned not to limit or define the presently described subject matter, but to provide examples to aid understanding of the concepts described in this application. Other aspects, advantages, and features of the presently described subject matter will become apparent after review of the entire application.

### BRIEF DESCRIPTION

A full and enabling disclosure is set forth more particularly in the remainder of the specification. The specification makes reference to the following appended figures.

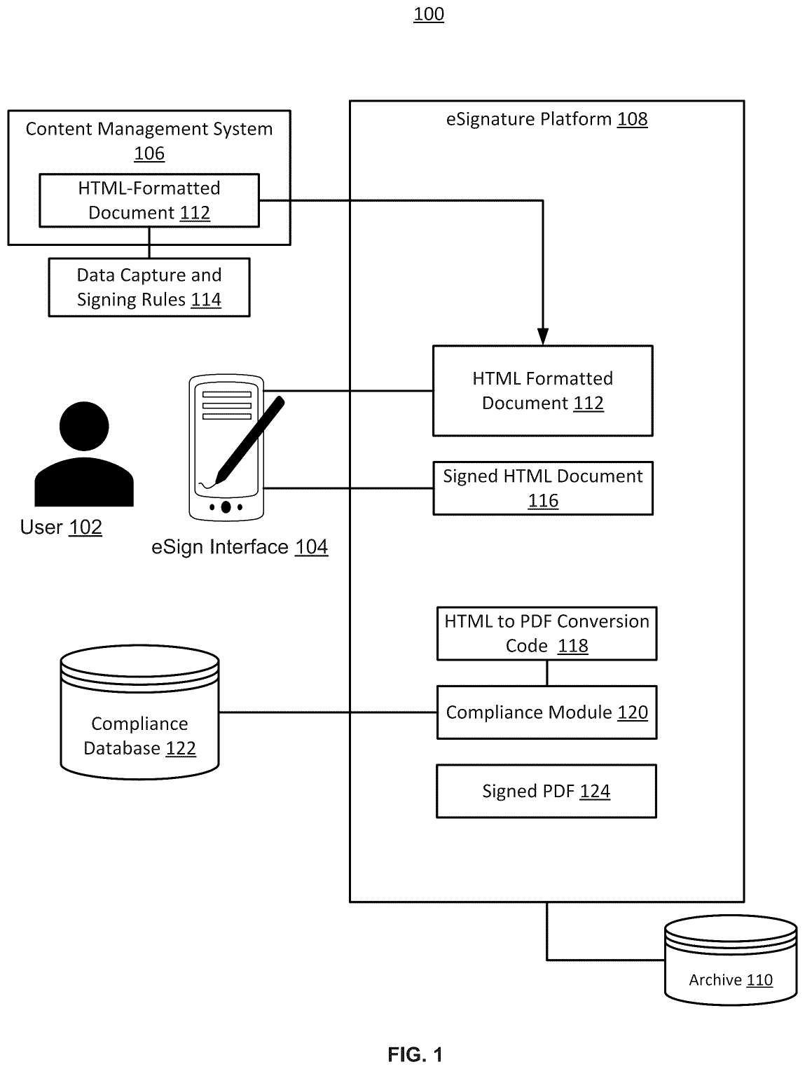

FIG. 1 illustrates a system for electronically signing HTML forms according to certain examples.

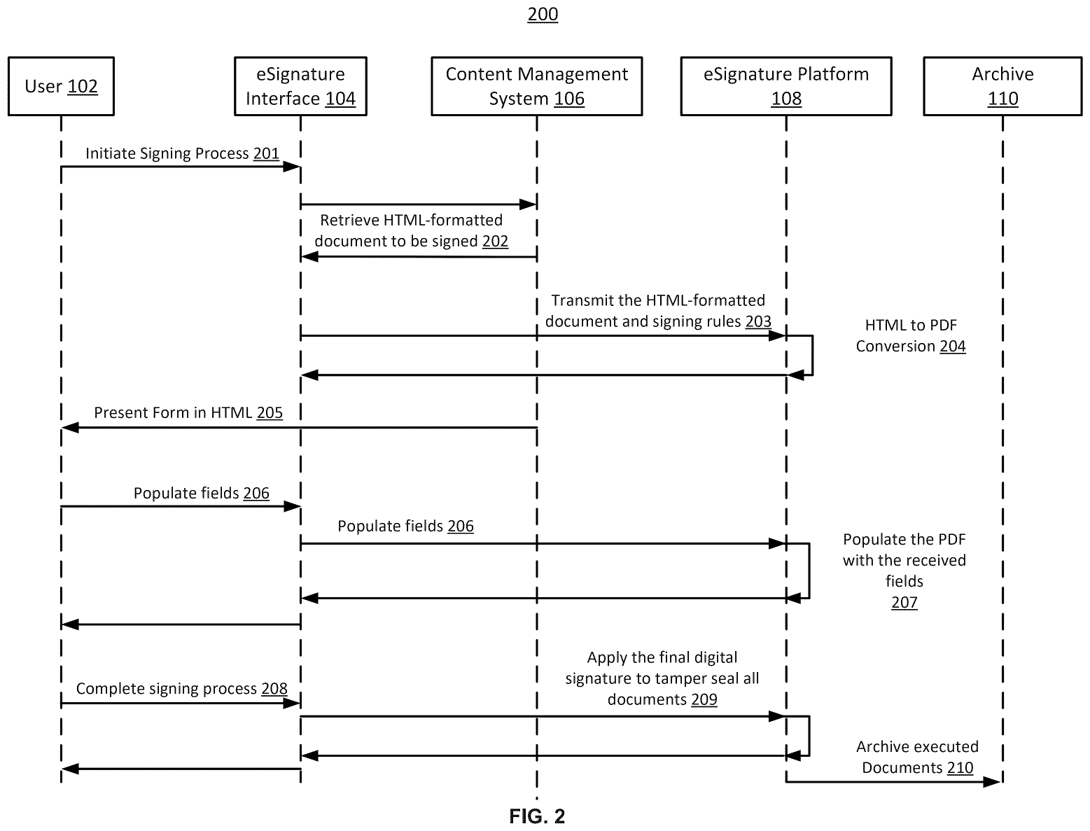

FIG. 2 is a swim lane diagram illustrating a method for electronically signing HTML forms using an eSignature platform. according to certain examples.

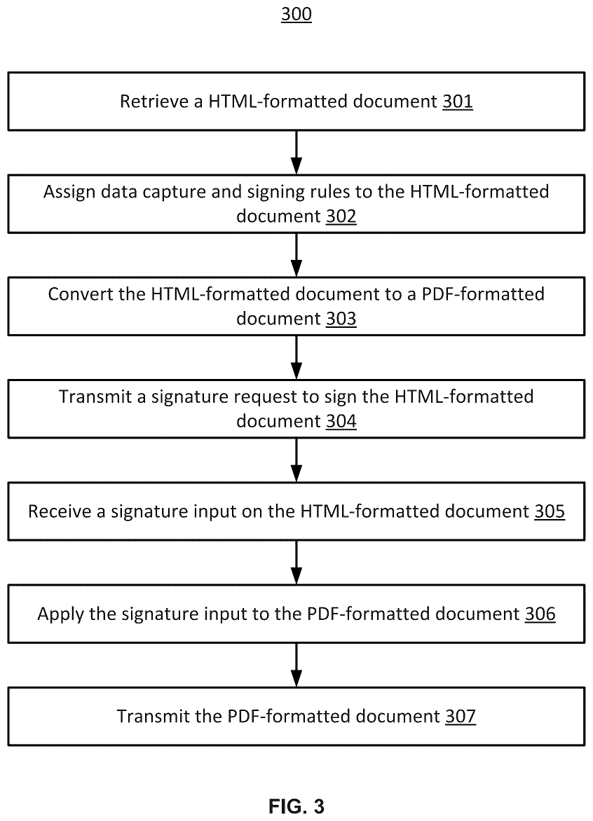

FIG. 3 illustrates a flow chart for electronically signing HTML files according to certain examples.

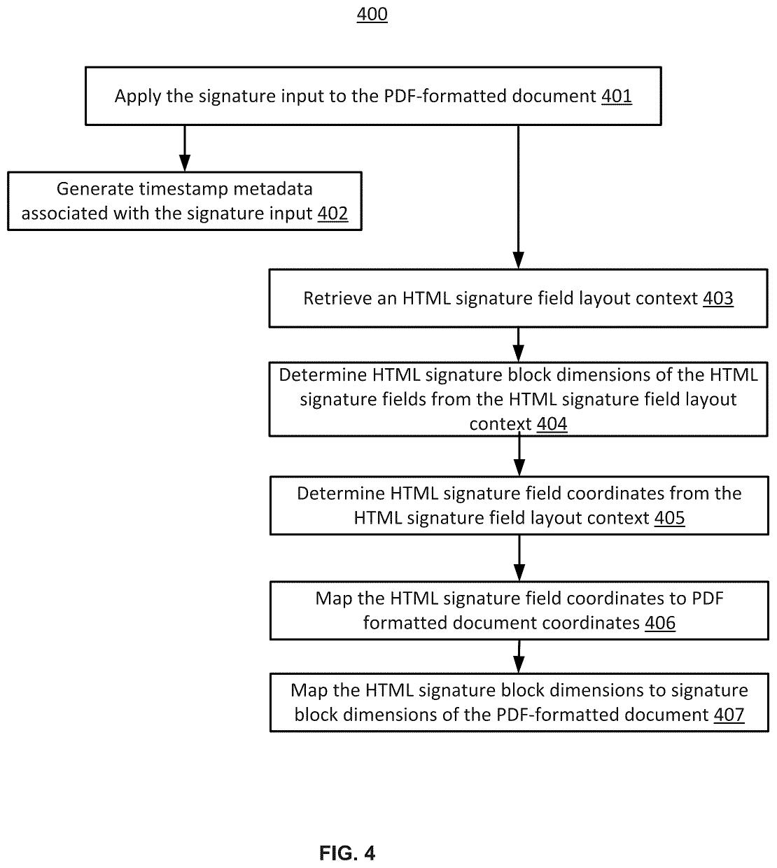

FIG. 4 illustrates a flow chart for applying signature inputs to PDF-formatted documents according to certain examples.

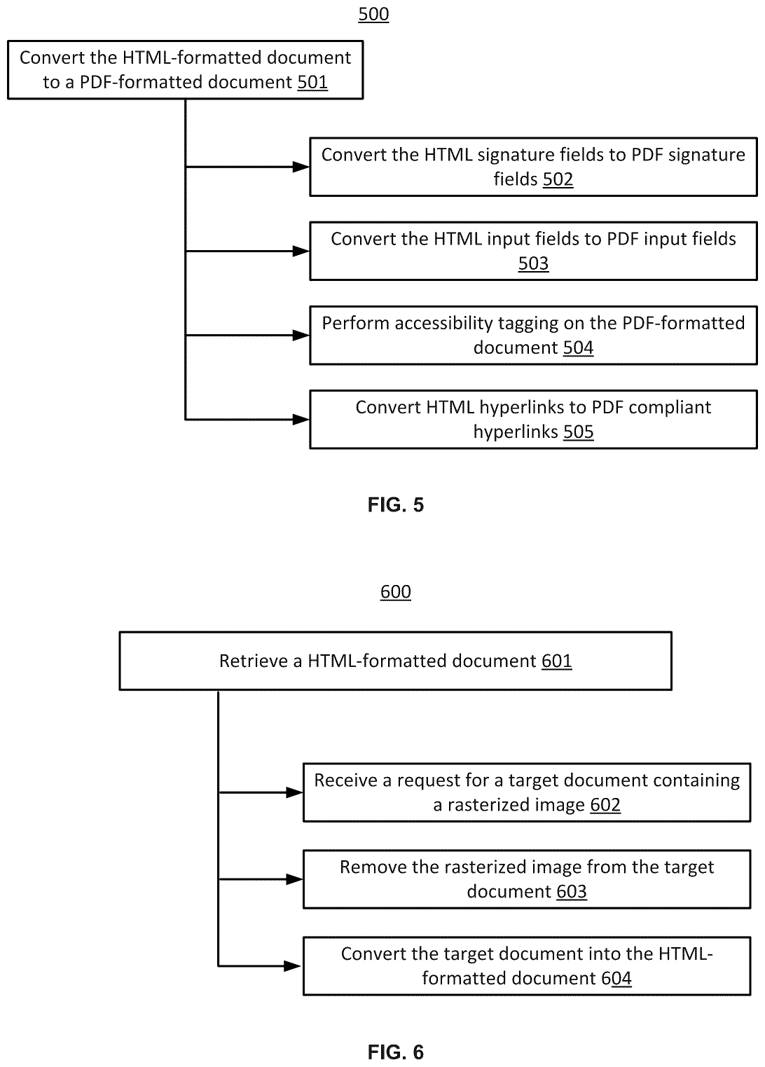

FIG. 5 illustrates a flow chart for converting HTML-formatted documents to PDF-formatted documents according to certain examples.

FIG. 6 illustrates a flow chart for generating HTML-formatted documents for subsequent conversion to PDF-formatted documents according to certain examples.

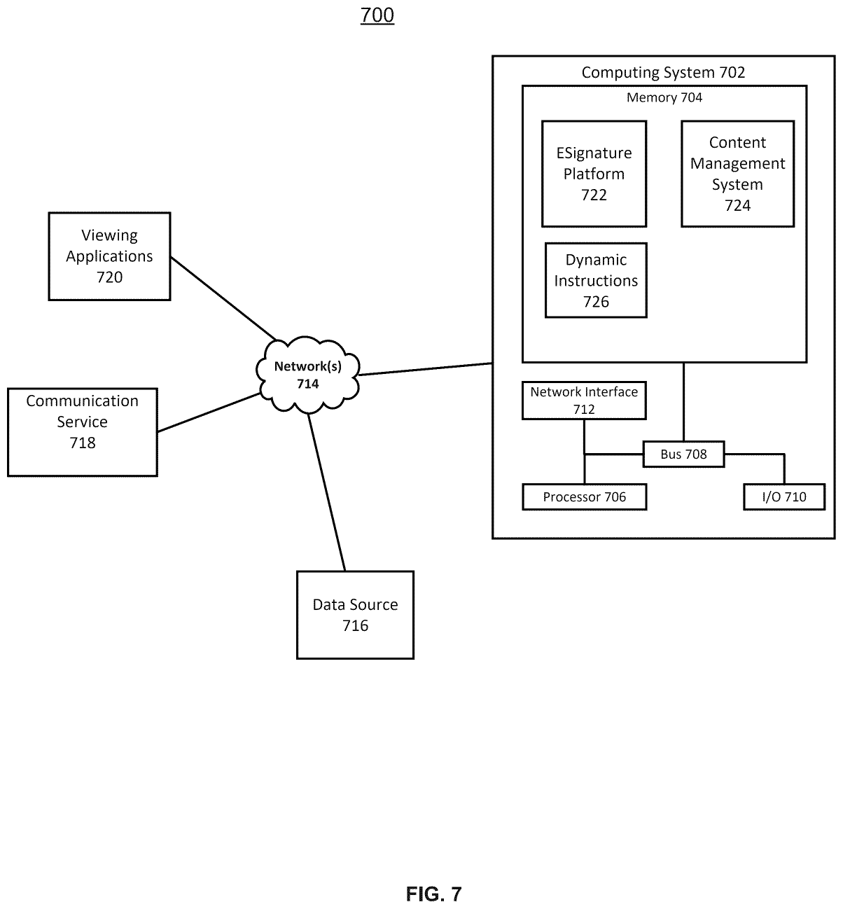

FIG. 7 illustrates a block diagram for an example computing environment capable of executing the described systems and methods.

### DETAILED DESCRIPTION

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of the appended claims and their equivalents.

### Illustrative Example for Electronically Signing HTML Forms

In one illustrative example, a system for electronically signing HTML forms includes an eSignature platform. The eSignature platform is capable of providing an interface to facilitate various signing ceremonies across an array of devices. The eSignature platform can provide a frontend experience to users the signing ceremonies via an HTML-formatted interface. By presenting to users the signature interface in HTML format, the eSignature platform can avoid deficiencies discussed above related to other file formats such as PDF format.

The eSignature platform can operate by receiving a request from a user to initiate a signing process, where the user inputs the request through the frontend interface. This may cause the eSignature platform to retrieve HTML content to be signed, such as an HTML-formatted document from a content management system storing a database of HTML content. The eSignature platform may then present a front-end signing experience to signing users via HTML-format. In addition, the eSignature platform can perform backend tasks of preparing a PDF-formatted document that traces the signing process performed on the HTML-formatted document per the frontend signing experience.

Backend operations of the eSignature platform may include, for instance, converting features of the HTML-formatted document such as HTML signing rules, HTML signature fields, input fields, and links to proper PDF format. Additionally, the eSignature platform can perform accessibility tagging on the generated PDF. While each signing user populates fields of the HTML-formatted document within the frontend signing experience, the eSignature platform in the backend operations can prefill data on the generated PDF-formatted document and apply the digital signatures as received at the frontend signing experience. Once the signing users complete the signing experience on the front end, the eSignature platform can apply the final digital signature to the PDF-formatted document and archive the finalized PDF-formatted document to complete execution of the signing ceremony. Thus, by providing a frontend signing experience according to one document format, while performing backend operations on a second document format, the eSignature platform can provide a seamless signing experience to various across various devices.

### Example System for Electronically Signing HTML Forms

FIG. 1 illustrates a system 100 for electronically signing HTML forms according to certain examples. The system 100 includes an eSignature platform 108 interfacing with a user 102, compliance database 122, and archive 110. The eSignature platform 108 comprising code and instructions for retrieving HTML-formatted documents 112 from the content management system 106, processing signatures on the HTML-formatted, and converting the HTML-formatted document into a PDF-formatted document. The eSignature platform 108 may be local to a personal computer or accessible through an internet interface, API, or the like.

The eSignature platform 108 interfaces with a content management system 106. The content management system may be a database capable of receiving and storing HTML-formatted documents 112 and other target files for electronically signing. The content management system 106 may include enterprise applications storing line of business data generated in the course of performing one or more business functions. The content management system 106 may also be communicatively coupled to one or more archives 110 which may provide for storage and accessing of signed documents such as the signed PDF-formatted document 124 following the completion of eSignature procedures.

The content management system 106 may include one or more HTML-formatted documents 112. The HTML-formatted documents 112 may generally include various elements defined within tags such as within <div> tags including <a> tag hyperlinks, and other tags and elements structurally and stylistically defining the HTML-formatted document 112. The content management system 106 may include additional HTML-relevant documents such as CSS files and JavaScript files further defining the structure and format of a given HTML-formatted document. In some examples, the content management system 106 stores other formatted documents that are then converted to HTML-formatted documents 112. For instance, a target file for signing may be include a document with rasterized images such as a PDF-formatted document or may otherwise be incompatible with HTML-format. The eSignature platform may convert the target file into an HTML-formatted document 112 for storage in the content management system 106.

Each of the HTML-formatted documents 112 may be associated with data capture and signing rules 114. The data capture and signing rules 114 may be assigned to a given HTML-formatted document by a line of business user or other user generating the requirements for a specific signing ceremony. For example, the HTML-formatted document 112 may contain input fields such as checkboxes, radio button selections, and the like. The data capture and signing rules 114 may specify, for a given HTML-formatted document 112 and signing ceremony, which input fields must be completed or modified before proceeding to the next stage in the signing ceremony. The data capture and signing rules 114 may also be user-specific, wherein a first user may be required to enter into certain input fields or sign in specified locations, while a second user may be required to enter into other input fields and sign in other locations. Any number of users may have associated tasks and signature to input into the HTML-formatted document 112 per the data capture and signing rules 114.

The eSignature platform 108 may receive a HTML-formatted document 112 from the content management system 106. For instance, the content management system may be configured to retrieve the HTML-formatted document 112 per a user request to initiate a signing process. The HTML-formatted document 112 may then be stored in the eSignature platform 108. The HTML-formatted document 112, once received by the eSignature platform 108 may then be presented to one or more users 102 during a signing ceremony through an eSignature interface 104. The eSignature interface 104 may be a computer, mobile device, or the like. Particularly, the eSignature interface presenting the HTML-formatted document 112 may be a mobile device such as a smartphone, wherein the mobile device has smaller screen compared to a computer display which may have been used to generate the HTML-formatted document 112.

One or more users 102 may have access to the eSignature interface 104. Each user 102 accessing the eSignature interface 104 may have associated user-metadata defining the user's role in the signing ceremony. The user-metadata may be associated with the user 102 based on authentication and access permissions. For instance, the eSignature interface 104 may only be accessible after a user provides credentials and passwords. Authentication means may also include multi-factor authentication, biometric authentication, and the like. By accessing the eSignature interface 104 per user-credentials, the one or more users 102 may be distinguished and provided a specific format of the HTML-formatted document 112 as defined by the data capture and signing rules 114.

Based on the data capture and signing rules 114 and the specific signing ceremony presented to the user 102, the eSignature platform 108 may receive a signature input by the user 102 through the eSignature interface 104. The eSignature interface 104, presented on a the user's 102 phone, may for instance be transmitted to a central server hosting the eSignature platform 108. The eSignature platform is able to receive multiple signatures from multiple signatures through eSignature interfaces 104 operating across various devices.

The eSignature platform 108 includes HTML to PDF conversion code 118, also referred to more generally as conversion code 118. The conversion code 118 stores programmed logic capable of converting the signed HTML-formatted document 116 to a signed PDF-formatted document 124. The logic and instructions executed by the conversion code 118 is further described with respect to FIGS. 3-5.

The eSignature platform 108 includes a compliance module 120 communicatively coupled to one or more compliance databases 122 and to the HTML to PDF conversion code 118. The compliance module 120 stores instructions for ensuring the HTML to PDF conversion code 118 converts the signed HTML-formatted document 116 to the signed PDF-formatted document 124 while maintaining compliance with one or more compliance requirements. Compliance requirements may include accessibility based requirements such as Americans with Disabilities Act (ADA) requirements, Web Content Accessibility Guidelines (WCAG) requirements, or the like. Compliance requirements may include compatibility requirements such as requirements defined by PDF, version 1.7. Compliance requirements may also include those defined by line of business protocols determined by a given line of business party to the signing ceremony. The compliance requirements may be stored and accessed by one or more compliance databases 122 such as those created and managed by the eSignature platform 108 host. Additionally or alternatively, the compliance module 120 may perform web-scraping to retrieve various compliance requirements such as those published online including ADA and WCAG requirements.

The eSignature platform 108, with the HTML to PDF conversion code 118, is able to generate a signed PDF-formatted document 124. The signed PDF-formatted document 124 may be transmitted back to the one or more users 102 for the user's own records and to indicate successful signing of the HTML-formatted document 112 now stored in PDF form. The signed PDF-formatted document 124 may also be sent to an archive 110 for long term storage and later retrieval. The archive 110 may for instance, be hosted by the eSignature platform 108 provider.

FIG. 2 is a swim lane diagram illustrating a method for electronically signing HTML forms using the eSignature platform 108 according to certain examples. The user 102 initiates the signing process 201 through the eSignature interface 104. For instance, the user 102 may open an application on a mobile device, the application providing the eSignature interface 104. In other examples, the eSignature interface 104 may prompt the user 102 of a pending signature awaiting the user's signing. The user 102 may then open the application hosting the eSignature interface 104 to initiate the signing process 201.

The eSignature interface 104 may then retrieve one or more HTML-formatted documents 112 to be signed 202 from the content management system 106. Depending on the signing ceremony, the eSignature interface 104 may retrieve one or multiple HTML-formatted documents 112. Once the eSignature interface 104 retrieve the HTML-formatted documents 112 to be signed, the eSignature interface 104 may then transmit 203 the HTML-formatted document 112 along with one or more signing rules. The signing rules may be defined within the HTML-formatted document 112, by the user 102 initiating the signing process, or by the signing ceremony.

The eSignature platform 108 may then perform HTML to PDF conversion procedures as defined by the HTML to PDF conversion code 118. The HTML to PDF conversion 204 procedure can include, among other procedures, converting HTML signature field to PDF signature fields; converting HTML input fields to corresponding PDF input fields; converting HTML links to PDF links; and performing accessibility tagging of the generated PDF. Once the eSignature platform 108 completes the HTML to PDF conversion 204 procedures, the eSignature platform may transmit the HTML-formatted document 112 to the eSignature interface 104 for populating by the user 102.

The user 102, receiving the HTML-formatted document on the eSignature interface 104 transmitted by the eSignature platform 108, may populate fields 206 the HTML-formatted document 112. The user 102 for instance can provide their signature at requested locations assigned by a given signing ceremony or signing rules. The user 102 may also populate the HTML-formatted document 112 by completing fields such as radio buttons, textboxes, and the like. The populated fields 206 may then be transmitted from the eSignature interface 104 to the eSignature platform 108. The eSignature platform may then populate 207 the PDF-formatted document generated during the HTML to PDF conversion 204, with the populated fields 206 received from the user 102 and eSignature interface 104.

Populating the PDF-formatted document with the received fields, such as applying the digital signature or applying the entered data from the eSignature interface 104 substantially completes the signature process. In addition, the eSignature platform 108 may transmit the PDF-formatted document, now populated with the user signature and other entered data back to the eSignature interface 104 for presentment to the user 102. The user may then confirm or accept the PDF-formatted document represents the completed signed document as entered on the HTML-formatted document 112.

Once the user confirms or accepts the PDF-formatted document, the eSignature platform 108 applies the final digital signature to tamper seal all documents 209.

FIG. 3 illustrates a flow chart 300 for electronically signing HTML files according to certain examples. The flow chart 300 illustrates how the eSignature platform, interacting with a user 102 and eSignature interface 104 can receive signatures from the user 102 to generate signed PDF 124-formatted document documents. Other examples may include more operations, fewer operations, different operations, or a different order of the operations shown in FIG. 3.

At block 301, the eSignature platform 108 retrieves a HTML-formatted document 112. The eSignature platform 108 may retrieve the HTML-formatted document 112 per a request from one or more users 102 initiating a request through the eSignature interface 104. Additionally or alternatively, the eSignature platform 108 may retrieve the HTML-formatted document 112 in response to signing ceremony uploaded to the eSignature platform 108. For instance, one user 102 may configure a signing ceremony with assigned rules and assigned users required to sign the document. In response, the eSignature platform 108 can retrieve the HTML-formatted document 112 per the signing ceremony and prompt one or more users to sign the document through the eSignature interface 104.

At block 302, the eSignature platform 108 assigns data capture and signing rules to the HTML-formatted document 112. The HTML-formatted document 112 may contain interactive elements such as input fields including checkboxes, radio buttons, and the like, such interactive elements may be associated with data capture rules and signing such as requiring a specified user to provide input into a subset of the interactive elements before being able to sign the document. The data capture and signing rules can also specify an order in which users 102 are presented the HTML-formatted document for signature during the signing ceremony. The eSignature platform 108 may receive the data capture and signing rules as input by a user 102 through an interface, such as the eSignature interface 104. Additionally or alternatively, the HTML-formatted document 112 may already store the data capture and signing rules. In some examples, the compliance module 120 may configure data capture and signing rules for the eSignature platform to assign.

At block 303 the eSignature platform 108 converts the HTML-formatted document to a PDF-formatted document. Converting the HTML-formatted document 112 to a PDF-formatted document at block 303 includes identifying interactive elements, such as the signature fields, input, fields, or HTML links, and converting them to corresponding PDF-compliant interactive elements. A PDF-formatted document may thus be generated at this block 303, by the eSignature platform, where the PDF-formatted document has interactive elements consistent with the HTML-formatted document. The eSignature platform 108 may further perform accessibility tagging of the generated PDF. In some examples, blocks 301-303 may be executed well in advance of blocks 304-307. For instance, when a HTML-formatted document is first retrieved per block 301, and the data capture and signing rules first assigned per block 302, the eSignature platform 108 may immediately perform the operations of block 303 to generate the PDF-formatted document and store the PDF-formatted document for subsequent execution of blocks 304-307. In such a way, the eSignature platform 108 can reduce subsequent delays in execution of blocks 304-307 by having pre-prepared the PDF-formatted document.

At block 304 the eSignature platform 108 transits a signature request to sign the HTML-formatted document 112. While the PDF-formatted document is stored in the a database accessible by the eSignature platform 108, the original, retrieved HTML-formatted document 112, that the PDF-formatted document was generated from, may be transmitted to a user interface, such as the eSignature interface 104, for signing by one or more users 102. The HTML-formatted document 112, containing no rasterized images, may be adaptable for display across a variety of eSignature interfaces 104. Particularly, providing benefits in mobile display over PDF format, the HTML-formatted document may be provided on a mobile device functioning as the eSignature interface 104. When multiple users are required to sign the HTML-formatted document 112, the eSignature platform 108 can retrieve the associated data capture and signing rules to transmit the signature request in accordance with a given signing ceremony. The eSignature platform 108 may thus transmit signature requests to multiple users 102 through multiple eSignature interface 104 in an order specified by the data capture and signing rules and the signing ceremony.

At block 305, the eSignature platform 108 receives a signature input on the HTML-formatted document 112. As at block 304, the eSignature platform can transmit signature requests to eSignature interfaces 104 including mobile devices including phones and tables. As such, users 102 can apply signature input by means of touchscreen and stylus responsive screens provided by such devices. As some users may find screen-responsive signatures preferable to signing documents per keyboard or mouse inputs, in some examples, a user may receive a request to sign a document on a computer-based interface, and the user may then transfer the request to a mobile device where the user 102 can sign in a more tactile friendly way (e.g., through a touchscreen interface).

In addition to receiving signature input on the HTML-formatted document at 112, the eSignature platform 108 can receive additional input from the one or more users 102 as input through an eSignature interface 104. Additional inputs can include populated input fields such as completed text boxes, selected radio boxes, and other inputs as entered per the data capture and signing rules. Additional inputs may also include changes to formatting of the text, highlights, and other modifications made to the HTML-formatted document as permitted by the data capture rules of the document.

At block 306, the eSignature platform 108 applies the signature input to the PDF-formatted document. Applying the signature input, received on the HTML-formatted document 112 may include various procedures to ensure proper formatting and verification that the signing ceremony has been completed. Additional procedures related to applying the signature input to the PDF-formatted document are described further with respect to FIG. 4.

At block 307, the eSignature platform 108 transmits the signed PDF-formatted document 124. The eSignature platform 108 may transmit the PDF-formatted document to a variety of users, user interfaces, archives, and programs communicatively coupled to the eSignature platform 108. In some examples, the signed PDF-formatted document 124 is transmitted back to the user 102 as proof of completion of the signing ceremony. Additionally or alternatively, the signed PDF-formatted document may be transmitted to one or more archives, such as archive 110 for compliance with document retention policies. In some examples, the compliance module 120 can retrieve document retention policies associated with a given signed-PDF document and configure the archive 110 for storage of the signed-PDF document in accordance with the associated document retention policy.

### Example Methods for Applying Signatures to the PDF-Formatted Document

FIG. 4 illustrates a flow chart 400 for applying signature inputs to PDF-formatted documents according to certain examples. The flow chart 400 illustrates how the eSignature platform 108 can perform operations to receive input signatures received on an HTML-formatted document 112 and convert the signature to PDF-formatted document. Other examples may include more operations, fewer operations, different operations, or a different order of the operations shown in FIG. 4.

At block 401, the eSignature platform 108 applies the signature input to the PDF-formatted document. Block 401 is similar to block 306, and further illustrates sub-procedures that may be applied with respect to the operations of block 306. Blocks 402 and 403-407 are shown independently stemming from block 401 indicating distinct procedures that may be performed in applying the signature input to the PDF-formatted document. In some examples, both blocks 402, and one or more of blocks 403-407 may be applied.

At block 402, the eSignature platform 108 generates timestamp metadata associated with the signature input. Timestamp metadata may be generated upon the user signing the HTML-formatted document 112. Additionally or alternatively, the timestamp metadata may be generated upon saving or transmitting the HTML-formatted document 112. The timestamp metadata may be saved to the generated PDF-formatted document as initially generated per block 303.

Blocks 403-407 illustrate further techniques for applying the signature input to the PDF-formatted document as described in blocks 303 and 401. Because the <Signature> tag on an HTML document is not a traditional HTML form field, additional processing steps may be required to identify HTML signature fields and convert them into signable AcroForm fields. Such procedures are described further with respect to blocks 403-407.

At block 403, the eSignature platform 108 retrieves an HTML signature field layout context from the HTML-formatted document 112. The eSignature platform 108 may perform operations including scanning the HTML-formatted document code to identify locations to insert <Signature> tags and to establish a signature field layout context. The HTML signature field layout context for instance may contain definitional bounds of a signature container, field, label or other structural definition of the signature as described in HTML. Dimensions retrieved may include border, height, margin, position, textual alignment, padding definitions and the like.

At block 404, the eSignature platform 108 determines HTML signature block dimensions of the HTML signature fields from the HTML signature field layout context. Block dimensions may include, for instance, height and width attributes, in addition to style attributes such as defining the thickness of the signature block border. Generally, the signature block dimensions may be a flat-box or rectangular based on the form field context. Surrounding lines may be removed. Determining the HTML signature block dimensions of the HTML signature field may further allow the eSignature platform 108 to define an occupied area in reference to PDF-formatted document size.

At block 405, the eSignature platform 108 determines HTML signature field coordinates from the HTML signature field layout context. can include HTML structure and CSS styling. As part of the coordinates of the HTML signature field layout context, positional coordinates, e.g., x, y, and z coordinates.

At block 406, the eSignature platform 108 maps the HTML signature field coordinates to PDF-formatted document coordinates. PDF-formatted document coordinates may be defined in Default or Rotated User Space and measured by PDF “point” measurements. e.g., 72 points per inch. Linear algebra techniques such as matrix multiplication may be used to convert HTML signature field coordinates to PDF-formatted document coordinates.

At block 407, the eSignature platform 108 maps the HTML signature block dimensions to signature block dimensions of the PDF-formatted document. Having retrieved the HTML signature field coordinates and mapped them to PDF-formatted document coordinates, the eSignature platform 108 can then directly overlay the HTML signature block in the same, preferably exact, position as defined in the PDF-formatted document. In such a manner, the process provides a seamless conversion from the HTML signature block to the PDF-formatted document, maintaining the look and feel of the original presented HTML signing.

FIG. 5 illustrates a flow chart 500 for converting HTML-formatted documents to PDF-formatted documents according to certain examples. The blocks 502-505 are shown stemming from block 501. The orientation of the blocks indicates that each of blocks 502-505 may be performed alone, or in various combinations with the other blocks 502-505.

At block 501, the eSignature platform 108 converts the HTML-formatted document to a PDF-formatted document. Block 501 is similar to block 303 of FIG. 3. Additionally, block 501 connects with blocks 502-505 further illustrating how the eSignature platform 108 performs block 301.

At block 502, the eSignature platform 108 converts the HTML signature fields to PDF signature fields. Processes similar to what has been described with respect to FIG. 4 may be applied wherein the eSignature platform, in converting HTML signature fields to PDF signature fields can include retrieving an HTML signature field layout context (e.g., according to block 403), determining dimensions, coordinates, and mapping.

At block 503, the eSignature platform 108 converts the HTML input fields to PDF input fields. Similar to block 502, the eSignature platform 108 can convert the HTML input fields to input fields with steps including identifying the HTML input field, determining dimensions, coordinates, and mapping.

At block 504, the eSignature platform 108 performs accessibility tagging on the PDF-formatted document. The eSignature platform 108 can, for instance, receive accessibility protocols and requirements such as ADA compliance requirements, WCAG compliance requirements, and/or the like from the compliance database 122. With the received accessibility protocols and requirements, the eSignature platform 108 may then scan the PDF-formatted document and apply the relevant accessibility tagging to ensure proper compliance. In some examples, the compliance database 122 can be programmed to scan online databases for additional accessibility protocols, or updates to preexisting protocols, and store them for future tagging per block 504.

At block 505, the eSignature platform 108 converts HTML hyperlinks to PDF compliant hyperlinks. The eSignature platform 108 can scan the HTML-formatted document for hyperlink elements, for instance, by scanning for “<a>” and “</a>” tags and href attributes. Once identified, the hyperlinks identified in the HTML-formatted document may be converted to PDF compliant hyperlinks. Additional styling and formatting as identified within the HTML-formatted hyperlinks may also be recorded and applied within the conversion process so that the formatting of the PDF compliant hyperlink preserves additional styling and formatting from the HTML-formatted document hyperlink.

### Example Methods for Preparing HTML-Formatted Documents

While generally, the eSignature platform 108 initiates the HTML to PDF conversion process by retrieving HTML-formatted documents 112 from the content management system 106, in some cases, the eSignature platform 108 may be further capable of converting various documents, HTML-formatted or otherwise, prior to other operations described herein. Thus, according to some examples, the eSignature platform 108 can generate the HTML-formatted documents 112 for storage in the content management system 106 and subsequent retrieval during the HTML to PDF conversion process (e.g., described with respect to FIG. 3).

FIG. 6 illustrates a flow chart 600 for retrieving HTML-formatted documents according to certain examples. The flow chart 600 illustrates how the eSignature platform 108 can perform operations to retrieve a document with rasterized images, or otherwise not compliant with HTML formatting, and convert the document to a HTML-formatted document 112. Other examples may include more operations, fewer operations, different operations, or a different order of the operations shown in FIG. 6.

At block 601, the eSignature platform 108 retrieves a HTML-formatted document 112. Block 601 is similar to block 303 of FIG. 3. Additionally, block 501 connects with blocks 502-505 further illustrating how the eSignature platform 108 performs block 501. Block 601 is representative of operations performed by blocks 602-604. In other words, blocks 602-604 illustrate operations, according to some examples, wherein the eSignature platform 108 performs block 601.

At block 602, the eSignature platform 108 receives a request for a target document containing a rasterized image. The target document may be a non-HTML-formatted document such as a PDF document. The target document may include, for instance, .JPEG, .PNG, .GIF, .TIFF or other image file formats.

At block 603, the eSignature platform 108 removes the rasterized image from the target document. The eSignature platform 108, may detect HTML-convertible elements, e.g., text, form field inputs, and hyperlinks, and similarly detect rasterized images in a target document. The detected rasterized images, which may otherwise prevent the conversion of the target document into the HTML-formatted document as stored in the content management system 106, may then be marked for deletion, or otherwise identified as an element not to be converted within the generated HTML-formatted document 112.

At block 604, the eSignature platform 108 converts the target document into the HTML-formatted document 112. Per the proceeding blocks, the eSignature platform 108 may convert elements such as text, form field inputs, and hyperlinks into HTML format, while ignoring the rasterized images in the HTML conversion process.

### Example Computing System for Implementing the eSignature Platform

Any suitable computing system or group of computing systems can be used for performing the operations described herein. For example, FIG. 7 illustrates a block diagram for an example computing environment capable of executing the described systems and methods, according to certain embodiments.

The depicted example of a computing system 702 includes one or more processors 706 communicatively coupled to one or more memory devices 704. The processor 706 executes computer-executable program code or accesses information stored in the memory device 704. Examples of processor 706 include a microprocessor, an application-specific integrated circuit (“ASIC”), a field-programmable gate array (“FPGA”), or other suitable processing device. The processor 706 can include any number of processing devices, including one.

The memory device 704 includes any suitable non-transitory computer readable medium for storing the eSignature platform 722, content management system 724, and other dynamic objects 726 or received or determined values or data objects. The computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C #, Visual Basic, Java, Python, Perl, JavaScript, and ActionScript.

The computing system 702 may also include a number of external or internal devices such as input or output devices. For example, the computing system 702 is shown with an input/output (“I/O”) interface 608 that can receive input from input devices or provide output to output devices. A bus 708 can also be included in the computing system 702. The bus 708 can communicatively couple one or more components of the computing system 702.

The computing system 702 executes program code that configures the processor 706 to perform one or more of the operations described above with respect to FIGS. 1-6. The program code includes operations related to, for example, receiving data capture and signing rules, receiving HTML signatures, and converting HTML-formatted data to PDF-formatted data, or other suitable applications or memory structures that perform one or more operations described herein. The program code may be resident in the memory device 704 or any suitable non-transitory computer-readable medium and may be executed by the processor 706 or any other suitable processor. In some embodiments, the program code described above, eSignature platform 722, content management system 724, and other dynamic objects 726 or received or determined values or data objects are stored in the memory device 704, as depicted in FIG. 7. In additional or alternative embodiments, one or more of the eSignature platform 722, content management system 724, and other dynamic objects 726 or received or determined values or data objects described above are stored in one or more memory devices accessible via a data network, such as a memory device accessible via a cloud service.

The computing system 702 depicted in FIG. 7 also includes at least one network interface 712. The network interface 712 includes any device or group of devices suitable for establishing a wired or wireless data connection to one or more data networks 714 such as viewing applications 720 including user interfaces. Non-limiting examples of the network interface 712 include an Ethernet network adapter, a modem, and/or the like. A remote communication service 718 is connected to the computing system 702 via network 712 and can perform some of the operations described herein including generating templates or receiving messaging data and applying the messaging data to a specified template. The computing system 702 is able to communicate with one or more of the remote communication service 718 and the eSignature platform 722 using the network interface 710. Although FIG. 7 depicts the eSignature platform 722 as connected to computing system 702 via the networks 712, other embodiments are possible, including the eSignature platform 722 running as a program in the memory device 704 of computing system 702.

### Advantages of Systems and Methods for a Message Dispatch Application

The described systems and methods provide an improved user signature interface for smaller screens such as mobile devices. Conventional methods of providing electronic signature involved presenting signing ceremonies via PDF-formatted documents or other rasterized image-based documents. However, such rasterized image-based documents are less compatible with respect to display across a variety of devices, such as mobile devices. Rasterized images presented on mobile devices allow for limited means of interacting with the underlying document, such as pinch/zoom to traverse the electronic display. By providing a HTML-based user interface to present signing ceremonies, the technical problems of interacting with traditional user signature interfaces can be resolved. Additionally, the field of document conversion between HTML-formatted documents 112 and PDF-formatted documents 124 is improved by providing for techniques to convert HTML-formatted documents 112 to PDF-formatted documents 124 while retaining features and functionality of the original HTML document such as hyperlink preservation, preserved accessibility and compliance tagging, and preserved tagging of additional data capture and signing rules.

### General Considerations

Although the subject matter has been described in language specific to structural features or methodological acts, it is to be understood that the subject matter of the appended claims is not necessarily limited to the specific features or acts described above. Rather, the specific features and acts described above are disclosed as examples.

Various operations of examples are provided herein. The order in which one or more or all of the operations are described should not be construed as to imply that these operations are necessarily order dependent. Alternative ordering will be appreciated based on this description. Further, not all operations may necessarily be present in each example provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has,” “with,” or variants thereof are used in either the detailed description or the claims, such terms are intended to be inclusive in a manner similar to the term “comprising”.

Further, unless specified otherwise, “first,” “second,” or the like are not intended to imply a temporal aspect, a spatial aspect, or an ordering. Rather, such terms are merely used as identifiers, names, for features, elements, or items. For example, a first state and a second state generally correspond to state 1 and state 2 or two different or two identical states or the same state. Additionally, “comprising,” “comprises,” “including,” “includes,” or the like generally means comprising or including.

Although the disclosure has been shown and described with respect to one or more implementations, equivalent alterations and modifications will occur based on a reading and understanding of this specification and the drawings. The disclosure includes all such modifications and alterations and is limited only by the scope of the following claims.

What is claimed is:

1. A method comprising:
retrieving a HTML-formatted document;
assigning data capture and signing rules to the HTML-formatted document;
converting the HTML-formatted document to a PDF-formatted document;
transmitting a signature request to sign the HTML-formatted document;
receiving a signature input on the HTML-formatted document;
applying the signature input to the PDF-formatted document; and
transmitting the PDF-formatted document.

2. The method of claim 1, wherein applying the signature input to the PDF-formatted document includes generating timestamp metadata associated with the signature input.

3. The method of claim 1, wherein converting the HTML-formatted document to the PDF-formatted document includes converting HTML signature fields to PDF signature fields and HTML input fields to PDF input fields.

4. The method of claim 1, wherein the signature input is received at a user-defined position on the HTML-formatted document; and the signature input is applied to the PDF-formatted document at a matching position on the PDF-formatted document.

5. The method of claim 4, wherein applying the signature input to the PDF-formatted document further comprises:
retrieving a HTML signature field layout context;
determining HTML signature block dimensions of the HTML signature fields from the HTML signature field layout context;
determining HTML signature field coordinates from the HTML signature field layout context;
mapping the HTML signature field coordinates to PDF-formatted document coordinates; and
mapping the HTML signature block dimensions to signature block dimensions of the PDF-formatted document.

6. The method of claim 1, wherein converting the HTML-formatted document to the PDF-formatted document includes performing accessibility tagging on the PDF-formatted document.

7. The method of claim 3, wherein converting the HTML-formatted document to the PDF-formatted document includes converting HTML hyperlinks to PDF compliant hyperlinks.

8. The method of claim 1, further comprising archiving the PDF-formatted document based on a document retention rule.

9. The method of claim 1, wherein the signature request is transmitted to a mobile device.

10. The method of claim 1, wherein retrieving the HTML-formatted document further comprises:
receiving a request for a target document containing a rasterized image;
removing the rasterized image from the target document; and
converting the target document into the HTML-formatted document.

11. A system comprising
one or more processors configured to:
retrieve a signing document comprising a HTML-formatted document;
assign data capture and signing rules to the HTML-formatted document;
convert the HTML-formatted document to a PDF-formatted document;
transmit a signature request to a user to sign the HTML-formatted document;
receive a signature input;
apply the signature input to the PDF-formatted document; and
transmit the PDF-formatted document.

12. The system of claim 11, wherein causing the one or more processors to convert the HTML-formatted document to the PDF-formatted document includes causing the one or more processors to:
generate timestamp metadata associated with the signature input.

13. The system of claim 11, wherein causing the one or more processors to convert the HTML-formatted document to the PDF-formatted document includes causing the one or more processors to:
convert a HTML signature fields to PDF signature fields and HTML input fields to PDF input fields.

14. The system of claim 11, wherein the signature input is received at user-defined position on the HTML-formatted document; and wherein the one or more processors are further configured to apply the signature input to the PDF-formatted document at a matching position on the PDF-formatted document.

15. The system of claim 11, wherein causing the one or more processors to apply the signature input to the PDF-formatted document further comprises causing the one or more processors to:
retrieve a HTML signature field layout context;
determine HTML signature block dimensions of the HTML signature fields from the HTML signature field layout context;
determine HTML signature field coordinates from the HTML signature field layout context;
map the HTML signature field coordinates to PDF-formatted document coordinates; and
map the HTML signature block dimensions to signature block dimensions of the PDF-formatted document.

16. The system of claim 11, wherein causing the one or more processors to convert the HTML-formatted document to the PDF-formatted document includes causing the one or more processors to:
perform accessibility tagging on the PDF-formatted document.

17. The system of claim 11, wherein causing the one or more processors to convert the HTML-formatted document to the PDF-formatted document includes causing the one or more processors to:
convert HTML hyperlinks to PDF compliant hyperlinks.

18. The system of claim 11, wherein the one or more processors are further configured to:
archive the PDF-formatted document based on a document retention rule.

19. The system of claim 11, wherein causing the one or more processors to transmit the signature request to sign the HTML-formatted document includes causing the one or more processors to:
transmit the signature request to a mobile device.

20. A non-transitory computer readable medium comprising instructions that, when executed by one or more processors, cause the one or more processors to:
retrieve a signing document comprising a HTML-formatted document;
assign data capture and signing rules to the HTML-formatted document;
convert the HTML-formatted document to a PDF-formatted document;
transmit a signature request to a user to sign the HTML-formatted document;
receive a signature input;
apply the signature input to the PDF-formatted document; and
transmit the PDF-formatted document.
